(19) United States
(12) Patent Application Publication
(10) Pub. No.: US 2008/0003952 A1
(43) Pub. Date: Jan. 3, 2008

(54) Method and Device in a Telecommunication System

(75) Inventors: Goran Sjostrom, Umea (SE); Soren Nyckelgard, Floda (SE)

Correspondence Address: OBLON, SPIVAK, MCCLELLAND MAIER & NEUSTADT, P.C., 1940 DUKE STREET, ALEXANDRIA, VA, 22314, US

(73) Assignee: TELIASONERA AB, Stockholm (SE)

(21) Appl. No.: 11/572,063

(22) PCT Filed: Jul. 6, 2005
(86) PCT No.: PCT/SE05/01127

§ 371 Date: Jan. 12, 2007

(30) Foreign Application Priority Data
Jul. 14, 2004 (SE) 0401869-3

(51) Int. Cl. H04B 1/40

(52) U.S. Cl. 455/74.1

(57) ABSTRACT

A system for connection of a fixed telephone to a mobile telecommunication network by an adapter/wire connected Home Base Station, WHBS, from a communication point of view wire connected to the fixed telephone and connected to a Home Base Station Controller HBSC via a data communication network. The Home Base Station Controller HBSC is, from a communication point of view, connected to the mobile communication network, and the adapter is arranged to emulate a mobile telephone, at which the fixed telephone is used as a keyset, microphone, and loudspeaker of the mobile telephone.

### TECHNICAL FIELD

The present invention relates to connection of a fixed telephone, PSTN-telephone, to a mobile communication network and its support system/systems.

### PRIOR ART

The telecommunication company Ericsson has developed a system which is called Mobile@Home™. This system is based on a gateway and Home Base Station Controller (HBSC) which locally can connect mobile telephones by means of Bluetooth/Wireless Fidelity (WiFi) to small Home (radio) Base Stations. These Home radio Base Stations are in their turn connected to the mobile communications network via broadband (IP). With Mobile@Home™, the mobile telephone is functioning in the same way as in the ordinary mobile communication network. All services which can be used in the mobile communications network also can be used in the system Mobile@Home™, but with the difference that higher data transfer rates can be provided.

Mobile@Home™ requires a mobile telephone which can communicate by means of Bluetooth and a Bluetooth communicating Home Base Station (HBS) which is located in the home or in an office. By means of a rapid IP-access, for instance ADSL or modem, the Home Base Station (HBS) connects to the mobile communication network via the Home Base Station Controller (HBSC). By Mobile@Home™, services can be provided with high bandwidth to mobile telephones, and the same services can be provided irrespective of whether the mobile telephone users are at home or in the office.

One disadvantage with the system Mobile@Home™ is that the ordinary PSTN-telephones cannot be handled in the support and service system of the mobile communication network. Instead, Mobile@Home™ requires that there is a separate PSTN support system or a separate VOIP telephone system to make it possible to connect ordinary PSTN-telephones to the telecommunication network. Consequently, the fixed telephony cannot have the use of/get access to/all service development made in the mobile telecommunication network, and the end user must have two telephone connections if he/she wants to utilize ordinary fixed telephones.

WO 01/03392 A1 describes a VoIP telephone system in which a gateway connects a mobile telephone to a computer network, such as Internet, in order to provide speech communication. The gateway allows user access from both wire connected and wireless telephone equipment, and provides a uniform service profile to the user irrespective of the user's location at the time of access.

US 2002/0114439 A1 describes a device for user transparent Internet telephony. The device includes a gateway which automatically detects the type of the telephone call which is made, and which connects the telephone call according to the result. If it is a local call, the gateway connects the call to an appropriate PSTN-network in ordinary way. If it is a trunk call, the gateway connects the call to a data communication network, such as Internet, via a broadband or modem setup, at which the call is executed via/by Internet telephony.

US 2002/0095516 A1 describes a system and a device for Internet telephony.

Consequently none of the documents WO 01/03392, US 2002/0114439 A1 and US 2002/0095516 A1 describes connection of a fixed telephone to a mobile communication network, at which the fixed telephony can get access to/use of/all service development which is made in the mobile telecommunication network.

U.S. Pat. No. 6,374,110 B1 describes a system and a method which makes communication between a Base Station Controller (BSC) in a cellular network and a fixed telephone system possible. Even though U.S. Pat. No. 6,374,110 B1 makes provisions of the same services to a wire connected user as to a mobile user possible, the system and the method according to U.S. Pat. No. 6,374,110 B1 differ essentially from the present invention.

### SUMMARY OF THE INVENTION

The present invention relates to connection of a fixed telephone, PSTN-telephone, to a mobile communication network and to the support system of the mobile communication network.

One aim of the present invention is to provide the fixed telephony with use of/access to all service development in the mobile telecommunication network.

One aspect of the aim is to save development resources in the fixed telecommunication network. At the same time an already existing terminal infrastructure in the market is used.

The present invention attains the above mentioned aim, and aspect of the aim, by providing a system, an adapter and a procedure according to the independent patent claims. Preferred embodiments of the present invention are defined by the depending patent claims.

Consequently, the present invention provides the fixed telephony with access to/use of/all service development in the mobile telecommunication network. This makes it possible to save development resources in the fixed telecommunication network, because PSTN-customers with need for the new services can be moved to a subscription on the adapter function according to the invention, a so called “Octopus-arrangement”, and the new services need not be introduced also into the fixed telecommunication network.

To the telephone operator, the present invention inter alia implies the following advantages:
Possibility to use only the mobile telephone system and the broadband network to handle home telephony in for the end user same or better way than today. I.e. subscription, billing, service development etc. are executed in one network, the core mobile network of today. This, in the long run, can imply a large-scale reduction of costs and gain of efficiency in the system development.
Possibility to provide a very attractive total telephony offer to all potential customers having broadband, i.e. in attractive way make possible to sell telephony over other's networks, for instance city networks, the Broadband Company etc. For instance might those segments/users which/who make most calls to mobile telephones have a, in comparison with for instance the Broadband Company, very attractive price of calls to mobile telephones from their home telephones. This might be especially attractive to young users who are making most calls to mobile telephones.
Possibility to, in a cost effective and to the customer/user economical way, offer a plurality of incoming and outgoing calls at the same time, on the same or separate subscriptions and by that get increased revenues.
Possibility to use the “Octopus” for access control, debiting and service distribution also of other services, such as IP-TV.

To a user, the present invention inter alia implies the following advantages:
Possibility to a plurality of incoming and outgoing calls in the same or a plurality of subscriptions. This can, for instance, be a great need for families with teenager children.
Possibility to, in a simple way, share the costs of the home telephony between those who are using it, for instance in families with teenager children, in collective dwelling and in smaller offices which have no telephone exchange.
Possibility to receive and transmit SMS and MMS in/from the home (strongly established user pattern regarding communication to a group in a home or in an office, cf illustrated postal cards or long delicate telephone calls).
Possibility to use the own mobile telephone also as wireless home telephone and by that evade the need to buy and carry a separate wireless telephone, so called DECT-telephone.

### BRIEF DESCRIPTION OF THE DRAWINGS

The present invention will be described in more detail in the following, with reference to enclosed drawings, in which

FIG. 1A schematically shows how a mobile telephone is connected to a mobile core network according to known technology;

FIG. 1B schematically shows how a mobile telephone is connected to the mobile core network according to the known system Mobile@Home™;

FIG. 1C schematically shows how a fixed telephone, PSTN-telephone, is connected to the mobile core network according to the present invention; and

FIG. 1D schematically shows how a fixed telephone, PSTN-telephone, is connected to a PSTN core network according to known technology.

### DESCRIPTION OF PREFERRED EMBODIMENTS

In the present description of the invention, the following abbreviations and acronyms will be used.
BSC Base Station Controller
DECT Digital Enhanced Cordless Telecommunications
GSM Global System for Mobile communication
HBS Home Base Station
HBSC Home Base Station Controller
IP Internet Protocol
MMS Multimedia Messaging Service
MSC Mobile Switching Center
PSTN Public Switched Telephone Network
RTP Real-time Transport Protocol
SIM Subscriber Identity Module
SMS Short Message Service
UDP User Datagram Protocol
UDP/IP UDP packets over IP
UMTS Universal Mobile Telecommunications System
VoIP Voice over IP
WAP Wireless Application Protocol
WiFi Wireless Fidelity

The present invention now will be described in more detail with reference to the figures.

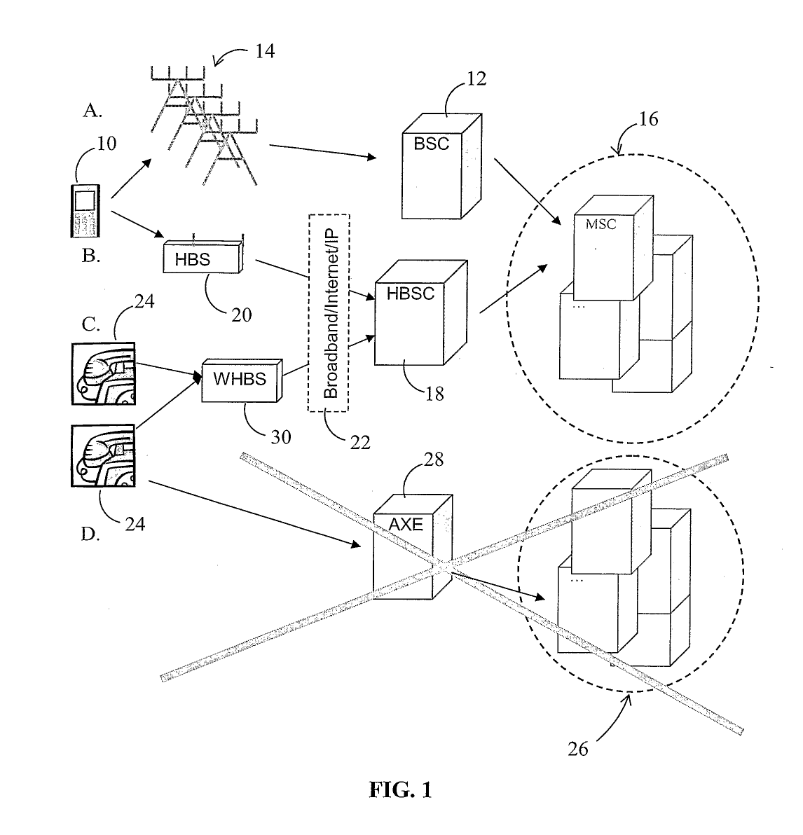

FIG. 1A shows schematically how a mobile telephone is connected to a mobile core network according to known technology. As is shown in FIG. 1A, a mobile telephone 10 is, from a communication point of view, connected to a Base Station Controller (BSC) 12 via a GSM/UTMS radio network and base stations 14. The Base Station Controller 20 is in its turn, from a communication point of view, connected to a mobile core network 16 which includes Mobile Switching Centra (MSC) and support and service systems.

FIG. 1B shows schematically how a mobile telephone 10 is connected to the mobile core network 16 according to the known system Mobile@Home™. As is shown in FIG. 1B, the mobile telephone 10 is, from a communication point of view, connected to a Home Base Station Controller (HBSC) 18 via a Home Base Station (HBS) 20. The mobile telephone 10 communicates wirelessly with the Home Base Station 20 by means of, for instance, Bluetooth/WiFi. The Home Base 20 Station 20 further is, from a communication point of view, connected to the Home Base Station Controller 18 by means of Broadband/Internet/IP 22. The Home Base Station Controller 18 is in its turn, from a communication point of view, connected to said mobile core network 18.

FIG. 1D shows schematically how a fixed telephone, PSTN-telephone, 24 is connected to a PSTN core network 26 according to known technology. As is shown in FIG. 1D, a fixed telephone 24 is, from a communication point of 30 view, connected to fixed core network 26 via a switching system 28, for instance a digital system such as AXE. The fixed core network 26 is a PSTN core network including support and service systems.

FIG. 1C shows schematically how a fixed telephone, PSTN telephone, 24 is connected to the mobile core network 16 according to the present invention. According to the invention, the fixed telephone 24 is connected to an adapter/Wire connected Home Base Station WHBS 30, also called “Octopus” 30. The adapter 30 is, from a communication point of view, connected to the Home Base Station Controller 18 by means of a data communication network 22, for instance Internet. The adapter 30 can, for instance, be connected to the Home Base Station Controller 18 via broadband and IP with, for instance, RTP over UDP/IP for speech, i.e. UDP-packets over IP. The adapter 30 is locally connected to the PSTN-telephone 24 by means of ordinary PSTN-connectors. Further, the Home Base Station Controller 18 is, from a communication point of view, connected to the mobile core network 16.

The adapter 30 according to the invention includes devices and is arranged to emulate a mobile telephone. The adapter 30 further is arranged to use the connected fixed telephone, the PSTN-telephone, 24 as the keyset, microphone and loudspeaker of the emulated mobile telephone.

To the Home Base Station Controller 18 the adapter 30 can be arranged to have the same interface as in the system Mobile@Home™. The interface of the adapter 30 to the fixed telephone 24 is so adapted that a user of the fixed telephone 24 experiences as if the fixed telephone 24 were connected to an ordinary PSTN-jack.

In one embodiment of the invention, the adapter 30 is equipped with a SIM-card reader (not shown), at which a subscription for the adapter 30 can be associated with a SIM-card which is inserted into the SIM-card reader. Consequently it will be possible to have one SIM-card per telephone subscription.

The adapter 30 also can be constructed to handle homes with a plurality of telephone subscriptions. The adapter 30 then is arranged for connection of a plurality of fixed telephones and arranged to provide one SIM-card reader per fixed telephone. However, it should be understood that it is possible to have one SIM-card for a plurality of fixed telephones, which makes a plurality of incoming and outgoing calls at the same time possible.

The adapter 30 further is arranged to provide the fixed telephones with access to/use of the value added services which exist in the mobile communication network, i.e. access to, on the whole, the same services as in the PSTN-network, for instance, number presentation, voice mail and so called PLUS-services such as three-party calls, blocking against number presentation, hot line connection, remote control, forwarding of call, and call back. To the customer, the same handling as in the PSTN-system of today can be provided, because the adapter 30 can be arranged to transform differences, if any, which exist between the mobile and the fixed communication networks.

The adapter 30 further can be arranged to include mobile telephone services such as SMS, MMS and WAP. These mobile telephone services either can be realized by the adapter 30 being equipped with a display screen (not shown), or that a stand alone wire connected unit (not shown) is connected to the adapter.

To sum up, the invention provides the fixed telephony with access to/use of/all service development in the mobile network. This, by that, can save development resources in the fixed network because PSTN-customers with need for the new services can be moved to a subscription on the adapter, a so called “Octopus” subscription, and by that the services need not be introduced also into the fixed network.

Consequently it, with the present invention, will be possible to handle PSTN-telephones in the support and service system of the mobile network, instead of in a separate PSTN support system or a separate VOIP telephone system. By this it will be possible for the operator to have only one support and service system, and one core network for telephony and other services.

The present invention has been described by means of schematic figures, but it should be understood that modifications can be made without these falling outside the frame of the idea of the invention, which only is limited by enclosed patent claims.

For instance, the system according to the invention can include a combined Home Base Station, HBS, and adapter. In such an embodiment, a user's mobile telephone can be used as home telephone, i.e. as the DECT-telephones are used today, when he or she is at home. In such an embodiment, both the mobile telephone and the fixed telephone then will ring at incoming telephone calls. The user by that can get access to/use of/wireless telephony at home without the need to buy and carry a separate wireless home telephone.

1-20. (canceled)

21. A system for connection of a fixed telephone to a mobile communication network, comprising:
an adapter/wire connected Home Base Station by wire connected to a fixed telephone and connected to a Home Base Station Controller via a data communication network,
the Home Base Station Controller further, from a communication point of view, being connected to the mobile communication network; and
the adapter configured to emulate a mobile telephone, at which the fixed telephone is used as a keyset, microphone, and loudspeaker of the mobile telephone.

22. The system as claimed in claim 21, wherein the adapter is locally connected to the fixed telephone by PSTN-connectors and to the Home Base Station Controller via P with RTP over UDP/IP

23. The system as claimed in claim 21, wherein an interface of the adapter to the fixed telephone is configured such that a user of the fixed telephone experiences as if the fixed telephone is connected to an ordinary PSTN-jack.

24. The system as claimed in claim 21 wherein the adapter includes a SIM-card reader, at which a subscription for the adapter can be associated with a SIM-card inserted into the SIM-card reader.

25. The system as claimed in claim 21, wherein the adapter is configured for connection of a plurality of fixed telephones and to provide one SIM-card reader per fixed telephone.

26. The system as claimed in claim 21, wherein the adapter is configured to provide fixed telephones with access to value added services that exist in the mobile communication network.

27. The system as claimed in claim 21, wherein the Home Base Station for mobile telephony and an adapter for fixed telephony are combined, at which both a mobile telephone and a fixed telephone can receive an incoming telephone call.

28. An adapter/wire-connected Home Base Station for connection of a fixed telephone to a mobile communication network, comprising:
an adapter by wire connected to the fixed telephone and, via a data communication network, connected to a Home Base Station Controller which, from a communication point of view, is connected to the mobile communication network;
the adapter further being configured to emulate a mobile telephone, at which the fixed telephone can be used as a keyset, microphone, and loudspeaker of the mobile telephone

29. The adapter as claimed in claim 28, wherein the adapter is locally connected to the fixed telephone by PSTN-connectors and to the Home Base Station Controller via IP with RTP over UDP/IP.

30. The adapter as claimed in claim 28, wherein an interface of the adapter to the fixed telephone is configured such that a user of the fixed telephone experiences as if the fixed telephone is connected to an ordinary PSTN-jack.

31. The adapter as claimed in claim 28, wherein the adapter includes a SIM-card reader, at which a subscription for the adapter can be associated with a SIM-card inserted into the SIM-card reader.

32. The adapter as claimed in claim 28, wherein the adapter is configured for connection of a plurality of fixed telephones and configured to provide one SIM-card reader per fixed telephone.

33. The adapter as claimed in claim 28, wherein the adapter is configured to provide fixed telephones with access to value added services that exist in the mobile communication network.

34. A procedure for connection of a fixed telephone to a mobile communication network, comprising:
by wire connecting an adapter/wire-connected Home Base Station to the fixed telephone and to connect the adapter to a Home Base Station Controller, via a data communication network;
from a communication point of view, connecting the Home Base Station Controller to the mobile communication network; and
by the adapter emulating a mobile telephone, at which the fixed telephone is used as a keyset, microphone, and loudspeaker of the mobile telephone.

35. The procedure as claimed in claim 34, further comprising locally connecting the adapter to the fixed telephone by PSTN-connectors and to the Home Base Station Controller via IP with RTP over UDP/IP.

36. The procedure as claimed in claim 34, further comprising arranging an interface of the adapter to the fixed telephone so that a user of the fixed telephone experiences as if the fixed telephone is connected to an ordinary PSTN- jack.

37. The procedure as claimed in claim 34, further comprising providing the adapter with a SIM-card reader, at which a subscription for the adapter can be associated with a SIM-card that is inserted into the SIM-card reader.

38. The procedure as claimed in claim 34, further comprising arranging the adapter for connection of a plurality of fixed telephones and to provide one SIM-card reader per fixed telephone.

39. The procedure as claimed in claim 34, further comprising arranging the adapter to provide fixed telephones with access to value added services that exist in the mobile communication network.

40. The procedure as claimed in claim 34, further comprising combining a Home Base Station for mobile telephony and the adapter for fixed telephony, at which both a mobile telephone and a fixed telephone can receive an incoming telephone call.
